(19) United States
(12) Patent Application Publication
(10) Pub. No.: US 2017/0160588 A1
(43) Pub. Date: Jun. 8, 2017

(54) REFLECTIVE TFT ARRAY PANEL, METHOD OF FABRICATING THE SAME AND LCD

(71) Applicant: Shenzhen China Star Optoelectronics Technology Co., Ltd., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 15/025,987

(22) PCT Filed: Jul. 30, 2015
(86) PCT No.: PCT/CN2015/085639

§ 371 Date: Mar. 30, 2016

(30) Foreign Application Priority Data
Jul. 14, 2015 (CN) 201510413303.0

(51) Int. Cl. G02F 1/1335; G02F 1/1343; G02F 1/1333; G02F 1/1368; G02F 1/1362

(52) U.S. Cl. CPC G02F 1/133553; G02F 1/1368; G02F 1/136286; G02F 1/133345; G02F 1/136227; G02F 1/134309; G02F 1/133514; G02F 1/13439; G02F 2201/123; G02F 2001/136295; G02F 2202/10

(57) ABSTRACT

The present disclosure proposes a reflective TFT array panel, a method of fabricating the reflective TFT array panel, and a liquid crystal display. The reflective TFT array panel includes: a substrate, a gate, a gate line, a reflective electrode, a reflective electrode connection line, a gate insulating layer, an active layer, a doping semiconductor layer, a source, a drain, a data line, an insulating protection layer, and a transparent pixel electrode. The reflective electrode connection line and the gate line are in parallel. The data line is perpendicular to the gate line and the reflective electrode, and the gate line, the reflective electrode connection line, and two of the neighboring data lines projecting onto the substrate form a rectangle. The reflective electrode is arranged in the rectangle, and the reflective electrode is a reflective metal electrode. The reflective TFT array panel is simple and has a larger reflective area.

### CROSS REFERENCE

This application claims the priority of Chinese Patent Application No. 201510413303.0, entitled “Reflective TFT array panel, method of fabricating the same and LCD”, filed on Jul. 14, 2015, the disclosure of which is incorporated herein by reference in its entirety.

### FIELD OF THE INVENTION

The present invention relates to the field of liquid crystal displays (LCDs), and more particularly, to a thin-film transistor (TFT) array panel and a method of fabricating the TFT array panel.

### BACKGROUND OF THE INVENTION

A thin film transistor-liquid crystal display (TFT-LCD) usually adopts the means of changing the circulation of liquid crystal molecules based on the intensity of the electric field in the liquid crystal layer and further controlling the strength of light transparency for image display. The TFT-LCD comprises a polarizer, a color film substrate, a TFT array panel, and a liquid crystal molecule layer sandwiched between the color film substrate and the TFT array panel. A TFT-LCD in the conventional technology usually comprises a backlight module called as transmissive TFT-LCD or semi-reflective semi-transparent TFT-LCD. The shortcomings of the conventional TFT-LCD are that the contrast and the brightness are greatly reduced in the environment of strong light. Especially, the display effect of the transmissive TFT-LCD used in outdoor display is quite terrible. However, the brightness and the contrast of a reflective TFT-LCD can still keep well in the environment of strong light because an outer light is used by the reflective TFT-LCD for better display. Also, no backlight modules are used in the reflective TFT-LCD. Thus, the reflective TFT-LCD is a low energy consuming and light-weight TFT-LCD, which is applicable to portable electronic devices. That's why the reflective TFT-LCD has become key equipment in the LCD industry.

To design a reflective TFT-LCD with a better effect, the polarization property of the polarizer or the type or performance of liquid crystal is frequently modified in the conventional technology. Otherwise, some components are added on the TFT array panel in the conventional technology for producing a reflective TFT-LCD with a better effect. However, these modifications are quite complicated with operational difficulties because the modifications relate to materials, structures, performances, etc. Also, the reflective area is small so it is hard to fully make use of ambient light.

### SUMMARY OF THE INVENTION

In light of this, the present invention manages to resolve the problem occurring in the convention technology with the method of: proposing a reflective TFT array panel having a simple structure and a large reflective area and an LCD comprising the TFT array panel for making best use of the ambient light completely, and further proposing a method of fabricating the reflective TFT array panel.

The present invention proposes a reflective thin-film transistor (TFT) array panel. The reflective TFT array panel comprises:

a substrate;

a gate, a gate line, a reflective electrode, and a reflective electrode connection line, formed on the substrate;

a gate insulating layer, formed on the gate, the gate line, the reflective electrode, and the reflective electrode connection line;

an active layer and a doping semiconductor layer, formed on the gate insulating layer in order, and located over the gate;

a source, a drain, and a data line, and the source and the drain formed on the doping semiconductor layer, and the data line being connected to the drain;

an insulating protection layer, formed on the source, the drain, and the data line;

a transparent pixel electrode, formed on the insulating protection layer, and being connected to the source through a hole.

The reflective electrode connection line and the gate line are in parallel. The data line is perpendicular to the gate line and the reflective electrode. The gate line, the reflective electrode connection line, and two of the neighboring data lines projecting onto the substrate form a closing rectangle. The reflective electrode is arranged in the rectangle, and the reflective electrode is a reflective metal electrode.

Furthermore, the gate, the gate line, the reflective electrode connection line, and the data line are all fabricated from reflective metal.

Furthermore, the reflective electrode comprises a rough and uneven surface.

Furthermore, a plurality of protrusive lines are arranged on the surface of the reflective electrode, and the distance between any two of the neighboring protrusive lines is smaller than 80 μm.

Furthermore, the reflective electrode is made of one of materials selected from aluminum, molybdenum, silver, titanium, copper, and chromium.

Furthermore, the reflective electrode, the gate, and the gate line are made by the same material.

Furthermore, the active layer is an amorphous silicon layer or a grapheme layer.

In another aspect, a liquid crystal display comprises a color filter, a reflective thin-film transistor (TFT) array panel as mentioned above, and a liquid crystal layer sandwiched between the color filter and the reflective TFT array panel.

The present invention also provides a method of fabricating a reflective thin-film transistor (TFT) array panel. The method comprises:

Step 1: depositing a layer of metal on a substrate using a method of physical vapor deposition (PVD), and forming a gate, a gate line, a reflective electrode connection line, and a reflective electrode by means of a first patterning process;

Step 2: depositing a gate insulating layer, an active layer, and a doping semiconductor layer on the substrate in order by means of plasma-enhanced chemical vapor deposition (PECVD) after Step 1 finishes, and forming patterns of the gate insulating layer, the active layer, and the doping semiconductor layer by means of a second patterning process;

Step 3: depositing a source/drain metallic layer on the substrate with the PVD technique after Step 2 finishes, and forming a drain, a source, and a data line by means of a third patterning process;

Step 4: depositing nitride or oxide based on silicon on the substrate with the PECVD technique after Step 3 finishes for forming an insulating protection layer, and forming a hole by means of a fourth patterning process;

Step 5: depositing transparent conductive material on the substrate with the PVD technique after Step 4 finishes, and forming a transparent pixel electrode by means of a fifth patterning process.

Furthermore, Step 1 is detailed as follows: using the PVD to deposit a layer of metal which is selected from a group of molybdenum, aluminum, chromium, silver, and copper on the substrate, and forming a gate, a gate line, a reflective electrode connection line, and a reflective electrode by means of the first patterning process.

Furthermore, the gate insulating layer in Step 2 is nitride or oxide based on silicon, the active layer is fabricated from amorphous silicon or grapheme, and the doping semiconductor layer is doped with amorphous silicon.

Compared with the conventional technology, the present invention provides the following effects: (1) A reflective electrode is arranged on a substrate in a reflective TFT array panel and an LCD, showing that the structure is simple; also, the reflective electrode as well as a gate and a gate line are fabricated in the same process, showing that the technique is easy and doable; (2) The reflective electrode is fabricated from reflective metal in the TFT array panel for making best use of the ambient light completely.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a top view of a reflective TFT array panel according to a preferred embodiment of the present invention;

FIG. 2 is a cross-sectional view along an A-A sectional line;

FIG. 3 is a cross-sectional view along a C-C sectional line;

FIG. 4 shows protrusive lines are arranged on the surface of the reflective electrode according to a preferred embodiment of the present invention;

FIG. 5 shows a flowchart of a method of fabricating the TFT array panel according to a preferred embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

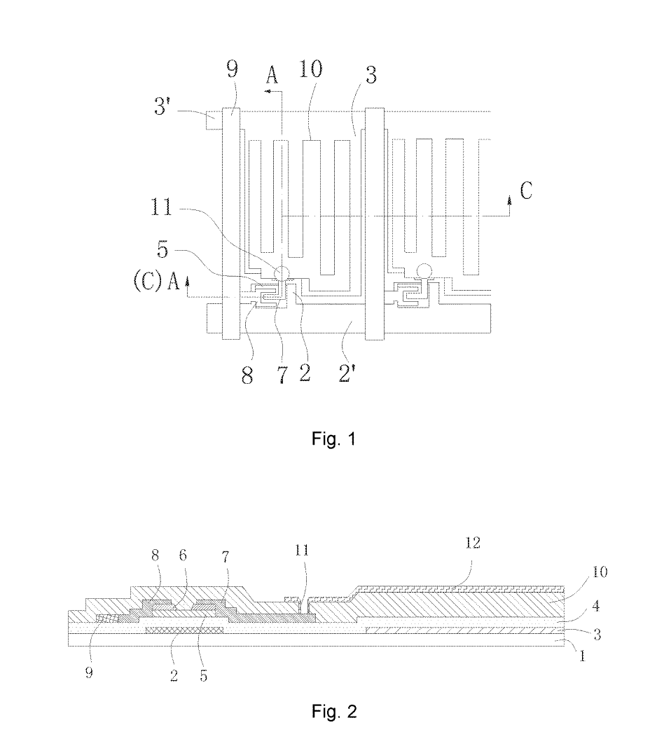

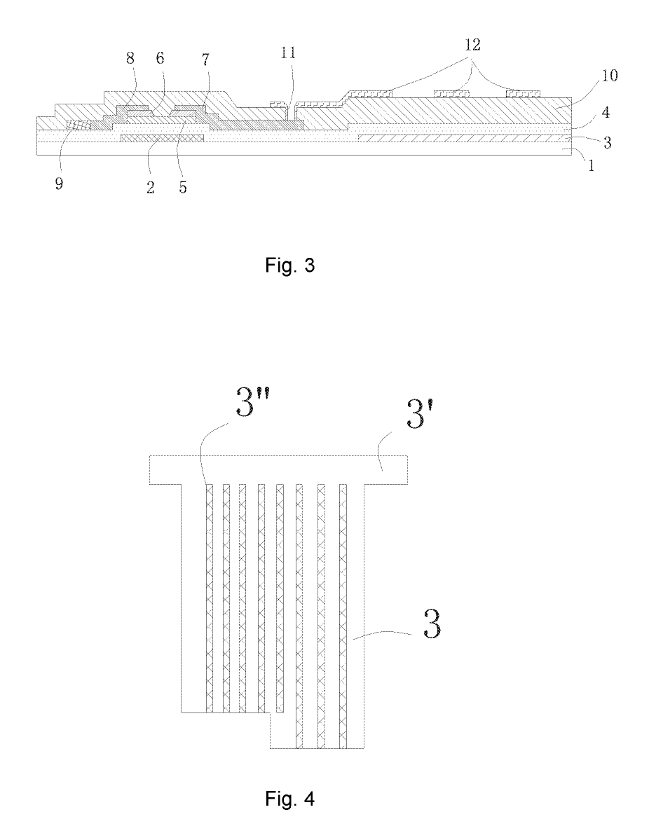

Please refer to FIG. 1, FIG. 2, and FIG. 3. FIG. 1 is a top view of a reflective TFT array panel according to a preferred embodiment of the present invention. FIG. 2 and FIG. 3 are cross-sectional views along an A-A sectional line and along a C-C sectional line, respectively. The reflective TFT array panel proposed by the embodiment comprises:

a substrate 1;

a gate 2, a gate line 2′, and a reflective electrode 3, being formed on the substrate 1, the gate 2, the gate line 2′, the reflective electrode 3 being arranged on an identical plane, each reflective electrode 3 being connected to each other through a reflective electrode connection line 3′, the reflective electrode connection line 3′ and the gate line 2′ being in parallel, the gate 2 being separated from the reflective electrode 3 and being arranged between the reflective electrode connection line 3′ and the gate line 2′, the gate 2, the gate line 2′, the reflective electrode 3, and the reflective electrode connection line 3′ being possible to be fabricated from the same material, such as aluminum, molybdenum, silver, copper, chromium and titanium, or an alloy of two or more materials selected from these metals.

a gate insulating layer 4, being a consecutively distributive layer, and being formed on the gate 2, the gate line 2′, the reflective electrode 3, and the reflective electrode connection line 3′;

an active layer 5, being formed on the gate insulating layer 4 and located over the gate 2; that is, the gate insulating layer 4 separating the active layer 5 from the gate 2, and the area of the active layer 5 being smaller than that of the gate 2;

a doping semiconductor layer 6, being formed on the active layer 5, being disconnected in the middle of the body for forming a channel; that is, the doping semiconductor layer 6 comprising two portions, and the space between the portions forming a channel;

a source 7, a drain 8, and a data line 9, the source 7 and the drain 8 being formed on the doping semiconductor layer 6, the data line 9 being connected to the drain 8, and the data line 9 being perpendicular to the gate line 2′ and the reflective electrode connection line 3′;

an insulating protection layer 10 and a hole 11, the insulating protection layer 10 being formed on the source 7, the drain 8, and the data line 9, and the hole 11 penetrating the insulating protection layer 10 and being connected to the source 7;

a transparent pixel electrode 12, being formed on the insulating protection layer 10 and being located on the reflective electrode 3; the transparent pixel electrode 12 being connected to the source 7 through the hole 11.

The reflective electrode connection line 3′ and the gate line 2′ are in parallel. The data line 9 is perpendicular to the gate line 2′ and the reflective electrode connection line 3′. The gate line 2′, the reflective electrode connection line 3′, and two of the neighboring data lines 9 projecting onto the substrate 1 form a closing rectangle. The gate 2 and the reflective electrode 3 are arranged in the rectangle, and the reflective electrode 3 is a metallic electrode.

Because the reflective electrode is fabricated from reflective metal, the light from the environment can be effectively reflected and fully used.

The gate line 2′, the reflective electrode connection line 3′, the data line 9, the gate 2, and the reflective electrode 3 are fabricated from reflective metal in this embodiment. In other words, the formed rectangle and the electrodes (i.e., the gate and the reflective electrode) arranged inside are both reflective. While all of the electrodes perform as usual, a larger reflective area is formed for making maximum use of the ambient light.

When incident ambient light are strong, some of the light will be reflected by the smooth surface of the display. After the light entering the reflective electrode in the TFT array panel is reflected and refracted by the flat surface of the display and then penetrates the surface of the display, the angle of the light may be the same as the angle formed by the light which is directly reflected by the smooth surface of the display. After the two reflected lights in the same direction overlap, the reflective lights may too strong, which may affect the display effect of the display. In light of it, the reflective electrode 3 comprises a rough and uneven surface. The incident ambient light becomes diffusely reflected through the reflective electrode 3. The directions of all of the reflected lights are different so the light reflected by the surface of the display in the same direction will not overlap. It ensures that the display has good display effect and good contrast.

Please refer to FIG. 4. A plurality of protrusive lines 3″ are arranged on the surface of the reflective electrode 3. The distance between any two neighboring protrusive lines 3″ is smaller than 80 μm. A concave is formed among the plurality of protrusive lines 3″. The concave functions as a light guide plate (LGP) does. The protrusive lines 3″ and the reflective electrode 3 can be fabricated from the same materials and be integrally formed. But it is also possible that the protrusive lines 3″ and the reflective electrode 3 are fabricated from different light guide materials in other embodiments. The direction extending along the protrusive lines 3″ is perpendicular to the reflective electrode connection line 3′. The distance among the plurality of protrusive lines 3″ is 70 μm. The direction extending along the protrusive lines 3″ can be arranged according to any directions designated by designers. The distance between any two neighboring protrusive lines 3″ can be designated by designers as well in other embodiments. In other words, the direction extending along the protrusive lines 3″ and the reflective electrode connection line 3′ can be in parallel. Or, the direction extending along the protrusive lines 3″ forms a certain angle with the protrusive line 3″. The distance between any two neighboring protrusive lines 3″ is between 10 μm and 50 μm.

The reflective electrode 3 is made of at least one of aluminum, molybdenum, silver, copper, and chromium in this embodiment.

The material which the reflective electrode 3 is fabricated from can be the same as that of the gate 2 and the gate line 2′ in this embodiment. However, it is allowable that the reflective electrode 3 and the gate 2 and the gate line 2′ are fabricated from different materials in this embodiment.

The active layer 5 is an amorphous silicon layer or a grapheme layer in this embodiment.

The transparent pixel electrode 12 has the structure of indium tin oxide (ITO) layer or the structure of metallic grids.

Further, an LCD is proposed by the present invention. The LCD comprises a color filter, a reflective TFT array panel, and a liquid crystal layer sandwiched between the color filter and the reflective TFT array panel.

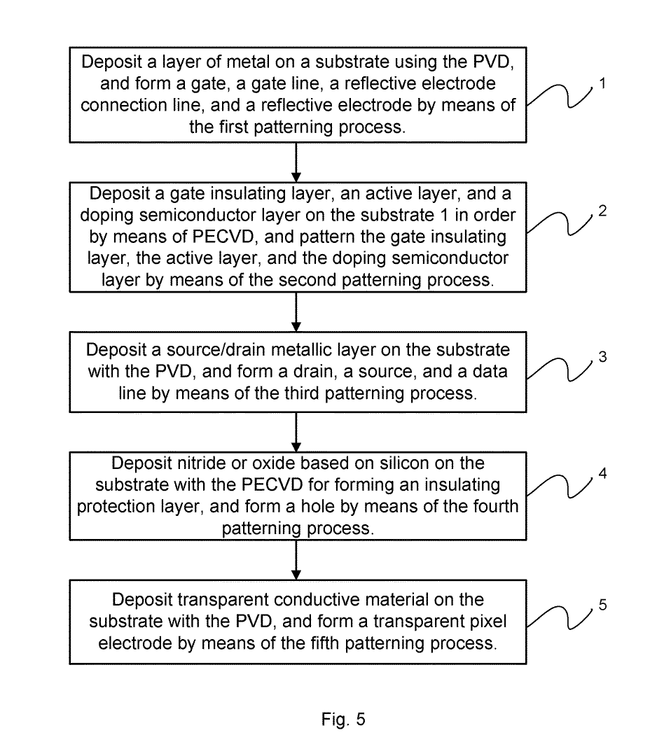

Further, a method of fabricating the TFT array panel is proposed. Please refer to FIG. 5. The method of fabricating the TFT array panel in the aforementioned embodiment as shown FIG. 1, FIG. 2, and FIG. 3 is elaborated. The method comprises following steps of:

Step 1: Deposit a layer of metal on a substrate using the physical vapor deposition (PVD), and form a gate, a gate line, a reflective electrode connection line, and a reflective electrode by means of the first patterning process. The first patterning process comprises exposure, development, wet-etching, and lifting-off.

Step 2: Deposit a gate insulating layer, an active layer, and a doping semiconductor layer on the substrate 1 in order by means of plasma-enhanced chemical vapor deposition (PECVD) after Step 1 finishes, and pattern the gate insulating layer, the active layer, and the doping semiconductor layer by means of the second patterning process. Preferably, the gate insulating layer, the active layer, and the doping semiconductor layer are formed after unnecessary materials are removed (in other words, keeping necessary materials) through exposure, development, dry-etching, and lifting-off in the second patterning process.

Step 3: Deposit a source/drain metallic layer on the substrate with the PVD after Step 2 finishes, and form a drain, a source, and a data line by means of the third patterning process. The data line and the source/drain are formed through exposure, development, wet-etching, and lifting-off in the third patterning process. Preferably, the drain, the source, and a channel therebetween are formed through dry-etching.

Step 4: Deposit nitride or oxide based on silicon on the substrate with the PECVD after Step 3 finishes for forming an insulating protection layer, and form a hole by means of the fourth patterning process. The fourth patterning process comprises exposure, development, dry-etching, and lifting-off.

Step 5: Deposit transparent conductive material on the substrate with the PVD after Step 4 finishes, and form a transparent pixel electrode by means of the fifth patterning process. Preferably, the transparent pixel electrode is formed through exposure, development, wet-etching, and lifting-off in the fifth patterning process.

The reflective electrode is directly arranged on the substrate in the reflective TFT array panel, and the reflective electrode and the gate line and the gate are fabricated in the same process. No extra processes are needed so the process proposed by the present invention is simple and easy to be performed.

Step 1 is detailed as follows: Depositing a layer of metal on the substrate using the method of PVD. The metal comes from at least one of molybdenum, aluminum, chromium, silver, and copper. The metal is fabricated into a gate, a gate line, a reflective electrode connection line, and a reflective electrode by means of the first patterning process.

The gate insulating layer in Step 2 is nitride or oxide based on silicon in this embodiment. Also, the active layer is fabricated from amorphous silicon or grapheme. The doping semiconductor layer is doped with amorphous silicon.

The thickness of the metallic layer in Step 1 is 3000 Å to 6000 Å in this embodiment.

The thickness of the gate insulating layer in Step 2 is 2000 Å to 5000 Å, and the thickness of both of the active layer and the doping semiconductor layer in Step 2 is 1500 Å to 3000 Å in this embodiment.

The thickness of the source/drain material layer in Step 3 is 3000 Å to 6000 Å in this embodiment.

The thickness of the insulating protection layer in Step 4 is 2000 Å to 5000 Å in this embodiment.

The thickness of the transparent conductive material in Step 5 is 400 Å to 1000 Å in this embodiment.

Above are embodiments of the present invention, which does not limit the scope of the present invention. Any modifications, equivalent replacements or improvements within the spirit and principles of the embodiment described above should be covered by the protected scope of the invention.

1. A reflective thin-film transistor (TFT) array panel, comprising:
a substrate;
a gate, a gate line, a reflective electrode, and a reflective electrode connection line, formed on the substrate;
a gate insulating layer, formed on the gate, the gate line, the reflective electrode, and the reflective electrode connection line;
an active layer and a doping semiconductor layer, formed on the gate insulating layer in order, and located over the gate;
a source, a drain, and a data line, and the source and the drain formed on the doping semiconductor layer, and the data line being connected to the drain;
an insulating protection layer, formed on the source, the drain, and the data line;
a transparent pixel electrode, formed on the insulating protection layer, and being connected to the source through a hole;
wherein the reflective electrode connection line and the gate line are in parallel, the data line is perpendicular to the gate line and the reflective electrode, and the gate line, the reflective electrode connection line, and two of the neighboring data lines projecting onto the substrate form a closing rectangle,
wherein the reflective electrode is arranged in the rectangle, and the reflective electrode is a reflective metal electrode.

2. The reflective TFT array panel of claim 1, wherein the gate, the gate line, the reflective electrode connection line, and the data line are all fabricated from reflective metal.

3. The reflective TFT array panel of claim 2, wherein the reflective electrode comprises a rough and uneven surface.

4. The reflective TFT array panel of claim 2, wherein a plurality of protrusive lines are arranged on the surface of the reflective electrode, and the distance between any two of the neighboring protrusive lines is smaller than 80 μm.

5. The reflective TFT array panel of claim 2, wherein a plurality of protrusive lines are arranged on the surface of the reflective electrode, and the distance between any two of the neighboring protrusive lines is between 10 μm and 50 μm.

6.-13. (canceled)

14. A method of fabricating a reflective thin-film transistor (TFT) array panel of claim 1, comprising:
Step 1: depositing a layer of metal on a substrate using a method of physical vapor deposition (PVD), and forming a gate, a gate line, a reflective electrode connection line, and a reflective electrode by means of a first patterning process;
Step 2: depositing a gate insulating layer, an active layer, and a doping semiconductor layer on the substrate in order by means of plasma-enhanced chemical vapor deposition (PECVD) after Step 1 finishes, and forming patterns of the gate insulating layer, the active layer, and the doping semiconductor layer by means of a second patterning process;
Step 3: depositing a source/drain metallic layer on the substrate with the PVD technique after Step 2 finishes, and forming a drain, a source, and a data line by means of a third patterning process;
Step 4: depositing nitride or oxide based on silicon on the substrate with the PECVD technique after Step 3 finishes for forming an insulating protection layer, and forming a hole by means of a fourth patterning process;
Step 5: depositing transparent conductive material on the substrate with the PVD technique after Step 4 finishes, and forming a transparent pixel electrode by means of a fifth patterning process.

15. The method of claim 14, wherein Step 1 is detailed as follows: using the PVD to deposit a layer of metal which is selected from a group of molybdenum, aluminum, chromium, silver, and copper on the substrate, and forming a gate, a gate line, a reflective electrode connection line, and a reflective electrode by means of the first patterning process.

16. (canceled)

17. The reflective TFT array panel of claim 4, wherein a direction extending along the protrusive line is parallel or perpendicular to the reflective electrode connection line, or the direction extending along the protrusive line forms an angle with the reflective electrode.

18. The reflective TFT array panel of claim 4, wherein material fabricated into the protrusive line is identical to material fabricated into the reflective electrode.

19. The reflective TFT array panel of claim 4, wherein material fabricated into the protrusive line is different from material fabricated into the reflective electrode.

20. The reflective TFT array panel of claim 4, wherein the protrusive line and the reflective electrode are integrally formed without being taken apart.

21. The reflective TFT array panel of claim 1, wherein the reflective electrode is made of one of materials selected from aluminum, molybdenum, silver, titanium, copper, and chromium.

22. The reflective TFT array panel of claim 1, wherein the active layer is an amorphous silicon layer or a grapheme layer.

23. The reflective TFT array panel of claim 1, wherein the transparent pixel electrode comprises the structure of indium tin oxide (ITO) layer or the structure of metallic grids.

24. A liquid crystal display, comprising a color filter, a reflective thin-film transistor (TFT) array panel as claimed in claim 1, and a liquid crystal layer sandwiched between the color filter and the reflective TFT array panel.

25. The method of claim 14, wherein the gate insulating layer in Step 2 is nitride or oxide based on silicon, the active layer is fabricated from amorphous silicon or grapheme, and the doping semiconductor layer is doped with amorphous silicon.
